(19) United States
(12) Patent Application Publication
(10) Pub. No.: US 2007/0187132 A1
(43) Pub. Date: Aug. 16, 2007

(54) Electrical cables

(76) Inventor: James Watt, Fife (GB)

Correspondence Address: Sue Z. Shaper, Suite 1450, 1800 West Loop South, Houston, TX, 77027, US

(21) Appl. No.: 11/704,576

(22) Filed: Feb. 9, 2007

(30) Foreign Application Priority Data
Feb. 13, 2006 (GB) 0602866.6

(51) Int. Cl. H01B 7/00

(52) U.S. Cl. 174/113 R; 174/113 C; 174/115

(57) ABSTRACT

A high frequency cable for the 0.5 MHz to 1000 MHz range including at least one twisted pair of conductors forming at least a part of a core, the core being covered by a sheathing, and the sheathing have a cross-sectional external shape in the form of a reuleaux polygon.

This application claims priority to UK application No. GB 0602866.6, “Improvements in and Relating to Electric Cables,” inventor James Watt, in th UK on Feb. 13, 2006.

### FIELD OF THE INVENTION

The present invention relates to high frequency communication cables designed for transmitting electrical signals at a frequency between 0.5 MHz and 1,000 MHz, hereinafter referred to as “the MHz range” of frequencies.

### BACKGROUND OF THE INVENTION

The latest development of Ethernet technology, which will run at speeds of 10Gbit/sec and which have a spectral energy across the 1-400 MHz frequency range, require a relatively ‘noise free’ transmission line. The simple solution to provide a ‘noise free’ line is to use screened cables, however, screened cables add complexity for the installer and so unscreened twisted pair cables (hereinafter referred to as “UTP cables) are generally preferred. A UTP cable comprises a number of pairs of insulated conductors encased in an outer sheath otherwise called sheathing, the insulated conductors in each pair being twisted together along their length. UTP cables may additionally provide physical separation between the individual pairs with a longitudinal spacer, divider or wall running the length of the cable.

The performance of UTP cables may be enhanced by increasing the balance of the pairs to reduce radiation and improve immunity and/or by increasing the physical separation of the pairs. Improving separation between cables is a relatively simple task, in that it is possible to make cables with a larger external diameter. However making a larger round cable has a number of disadvantages, for example, increased size and weight and reduced flexibility of the cable. This makes it more difficult to install the cable and results in increased use of frequently limited installation tray space in buildings.

To solve this problem several cable manufacturers have introduced new UTP cable designs which achieve spatial separation by introducing a spiral thread into the cables, by making flat or ‘dogbone’ shaped cables, or by making larger round cables incorporating thicker sheathing. Disadvantages with these known attempts at providing,an improved cable include the large amount of material is required for thicker sheathing and or a lack of flexibility of the cables for thick sheathing or in particular planes for special shaped cables.

Cable to cable cross-talk arises where there are cables in close proximity, particularly where they are of a similar construction with the same lay of twisted pairs. Manufacturing tolerances result in the twisted pairs being unbalanced, and hence an electromagnetic coupling can arise between twisted pairs in adjacent cables. This results in electrical noise being transmitted from one cable to another. This is known as “alien cross-talk”. Increasing the distance between the twisted pairs of adjacent cables reduces the transmission of noise in proportion to a logarithm of the distance.

An alternative solution of improving the balance of twisted pairs is prohibitively expensive, since the manufacturing equipment is highly specialized and involved.

### SUMMARY OF THE INVENTION

According to the present invention there is provided a high frequency cable for the MHz range having at least one twisted pair of conductors forming at least a part of a core, the core being covered by sheathing, the sheathing having a cross sectional external shape substantially in the form of a reuleaux polygon.

A reuleaux polygon of this invention is a shape constructed around a form having an odd number of sides. Where each of the said sides of the form is curved, the radius of the curvature is substantially the same as the maximum width. Hence, each of the sides is curved, with a radius of curvature substantially the same as the constant width.

A benefit of providing a cable where the sheathing has a cross-sectional external shape in the form of a reuleaux polygon is that cable separation may be increased while the cross-sectional area of the cable may be decreased, hence improving flexibility of the cable and reducing weight and cost when compared with an equivalent size cable with a circular external cross-sectional shape.

The reuleaux shape of the invention preferably has three sides. More preferably each of the three sides is substantially the same geometric shape.

A benefit of the reuleaux shape having three sides is that this shape has a minimum cross sectional area for a maximum cross-sectional constant width. Hence a spacing of adjacent cables is increased without a proportional increase in material used in the sheath.

The reuleaux shape of the invention preferably has a continuously curved surface with a minimum radius at the apices of the three cornered shape being at least 5% of the large constant width of the shape. More preferably the minimum radius at the apices is at least 10% of the large constant width of the shape.

A benefit of the continuously curved shape is that an extruded cable sheathing of this shape is easier to manufacture consistently than with one with a smaller apex radius.

A further benefit of the continuously curved shape is that the cable sheathing is easier for an installer to handle, and does not catch on edges during installation as would a cable sheathing with a smaller apex radius.

The sheath is preferably arranged to surround the conductors and spacing member so as to leave air space between the conductors and a bore of the sheath.

The cable is preferably structured together with the sheathing extruded over the conductors such that the sheathing does not adhere to the conductors.

A benefit of the sheathing not adhering to the conductors is that a flexibility of the cable is enhanced, and it may be more easily routed round bends without undue stressing of the conductors.

### BRIEF DESCRIPTION OF THE DRAWINGS

A better understanding of the present invention can be obtained when the following detailed description of the preferred embodiments are considered in conjunction with the following drawings, in which:

Specific embodiments of the invention will now be described by way of example with reference to the accompanying drawings in which: FIG. 1 is a perspective view of an end of a UTP cable of a first embodiment of the invention;

FIG. 2 is a cut end view of the UTP cable shown in FIG. 1, showing in effect a cross-section of the UTP cable of the invention;

FIG. 2A is the same cut end view as shown in FIG. 2, with additional geometrical construction shapes shown in broken lines;

FIG. 3 is a cut end view of a known round UTP cable, having a circular external shape and having a closely similar cross-sectional area to the cable shown in FIGS. 1 and 2;

FIG. 4 is a cross-sectional view of a bundle of the cables shown in FIG. 1;

FIG. 5 is a cross-sectional view of a bundle of the cables shown in FIG. 3;

FIG. 6 is a graph showing actual test results of cable according to the invention;

FIG. 7 is a cut end view of an end of a UTP cable of a second embodiment of the invention;

FIG. 8 is a cut end view of an end of a UTP cable of a third embodiment of the invention; and

FIG. 9 is a cut end view of an end of a UTP cable of a fourth embodiment of the invention.

The drawings are primarily illustrative. It would be understood that structure may have been simplified and details omitted in order to convey certain aspects of the invention. Scale may be sacrificed to clarity.

### DETAILED DESCRIPTION OF THE PREFERRED EMBODIMENTS

From FIG. 1, a perspective view of a first embodiment of an electrical cable 1 according to the invention is shown. The electrical cable 1 has an extruded sheathing 2 covering a core 3. The core comprises four substantially identical twisted pairs 4, 5, 6, and 7 of conductors. Each twisted pair having two substantially identical conductors 8 and 9. Each conductor having a conductive core 10 and insulation 11. The twisted pairs are spaced apart by an insert 12 which extends along the length of the cable. The sheathing 2 is preferably extruded around the core 3 such that air spaces 13 are left between a tubular inner surface 14 of a bore 24 of the sheathing and the insulation 11 of the conductors. The sheathing is preferably extruded over the conductors so that the sheathing 2 does not adhere to the conductors 8 and 9 of the twisted pairs 4, 5, 6 and 7. An external shape 15 of the sheathing 2 is substantially in the form of a reuleaux polygon 16, and in this preferred embodiment is in the form of a three sided polygon having curved sides 17, 18 and 19. To facilitate manufacture and improve the ease of handling the cable, each of the apices 20, 21 and 22 of the reuleaux polygon 16 are each provided with a fillet radius 20R, 21R and 22R. The fillet radii are arranged to blend into the adjacent curved sides 17, 18 and 19 so that an external surface 23 of the cable is smoothly curved around its periphery.

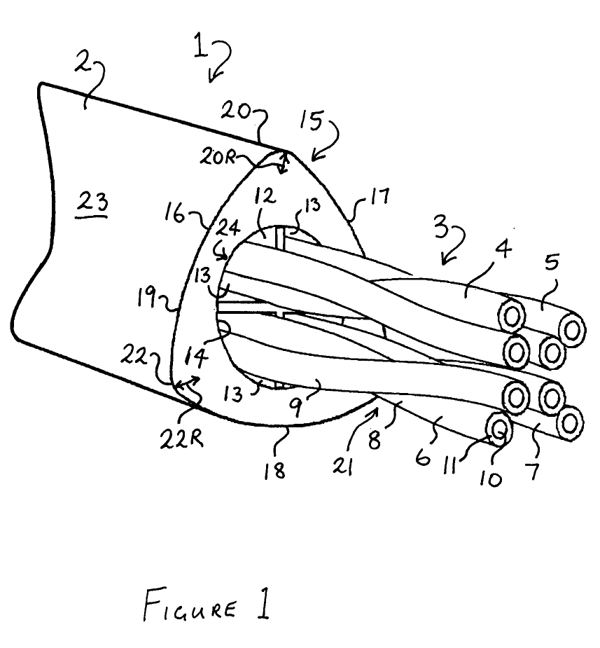

FIGS. 2 and 2A show an end view of a cut length of the cable 1 of the embodiment shown in FIG. 1. The external shape 15 can be seen to be substantially a three sided reuleaux polygon, with a constant width 2W across the shape. Hence, each of the sides is curved, with a radius of curvature 2C substantially the same as the width 2W.

Straight lines joining the apices 20, 21 and 22 would form a triangle shown in FIG. 2A by a dotted line.”

A circle drawn so as to just encompass the external shape 15 has a diameter of 2M.

A circle having a diameter of 2N shows the equivalent circular shape having the same cross-sectional area as the reuleaux polygon of the first embodiment.

The tubular inner surface has an internal diameter 2D. Diameter 2D is arranged to be of a sufficient size to contain the core 3.

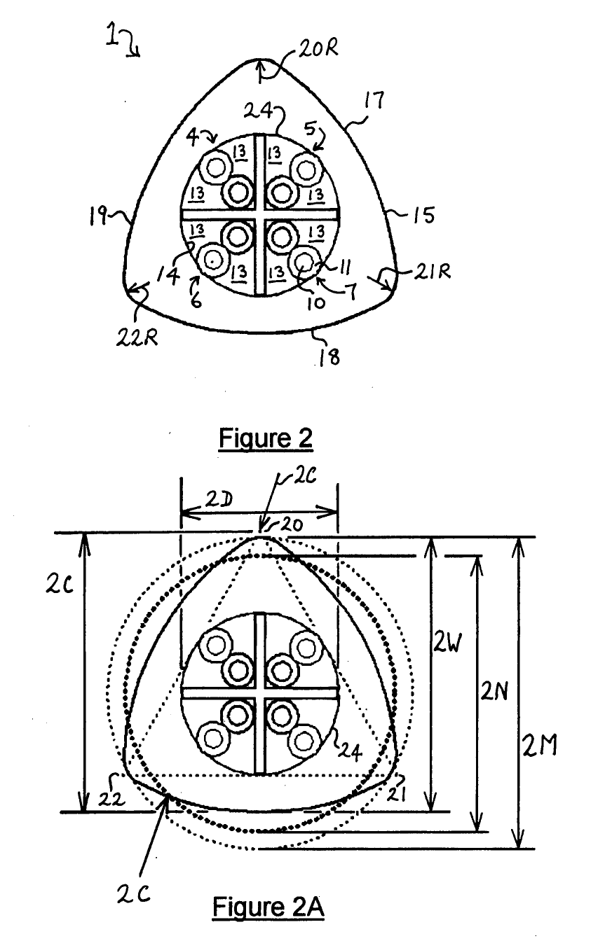

FIG. 3 is a cut end view of a known round UTP cable 300, having a circular external shape 301 with a diameter 300X and having a closely similar cross-sectional area to the cable shown in FIGS. 1 and 2. The core 303 of this cable is identical to the core of the cable shown in FIGS.1 and 2.

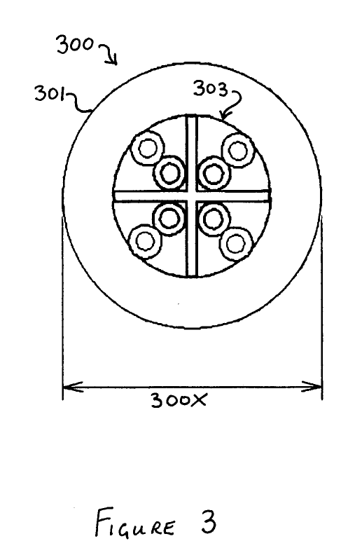

In FIG. 4, a bundle of seven cables 1′ as cable 1 shown in FIG. 1, can be seen tightly packed. A minimum spacing 4U between centres of adjacent cables is generally achieved in practice, resulting from the interaction of the external shapes of the adjacent cables in the bundle. Large irregular air gaps 41 are left between the adjacent cables 1′. Dotted line circles 41 indicate an approximate equivalent circular diameter, equivalent to an effective diameter of the cables of the first embodiment when they are bundled together. A cross-sectional area of the dotted line circles 41 is more than a cross-sectional area of the substantially reuleaux polygon 43 of the actual cable. A dashed line circle 44 shows a pitch circle through a mid-point of the twisted pair wires.

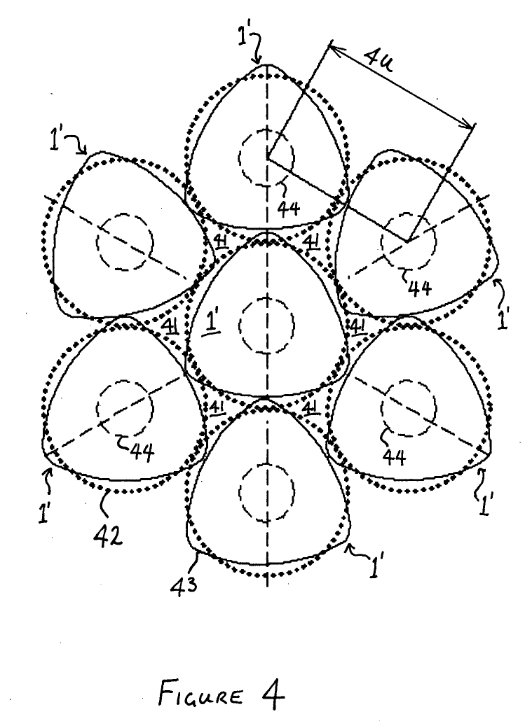

From FIG. 5 a comparative bundle of known round cables 300′ as shown in FIG. 3 can be seen to form a regular closely abutting bundle, with small even air gaps 51 between the adjacent cables 300′. A minimum spacing 5V between the centres of adjacent cables results from the regular shape of the bundle. A dashed line circle 54 shows a pitch circle through a mid-point of the twisted pair wires.

The minimum spacing 5V is smaller than the minimum spacing 4U.

Typically a value for 5V would be approximately 8.1 mm and a value for 4U would be 8.6 mm.

Since the beneficial effect of the spacing of the adjacent twisted pairs in minimizing alien cross-talk is logarithmically proportional to the spacing, a relatively small increase in spacing results in a significant improvement by reducing alien cross-talk.

As cables tend to have a twist as they are laid, besides the distance between closest twisted pairs in adjacent cables, the centre to centre distance between adjacent cables is relevant in consideration of reducing alien cross-talk.

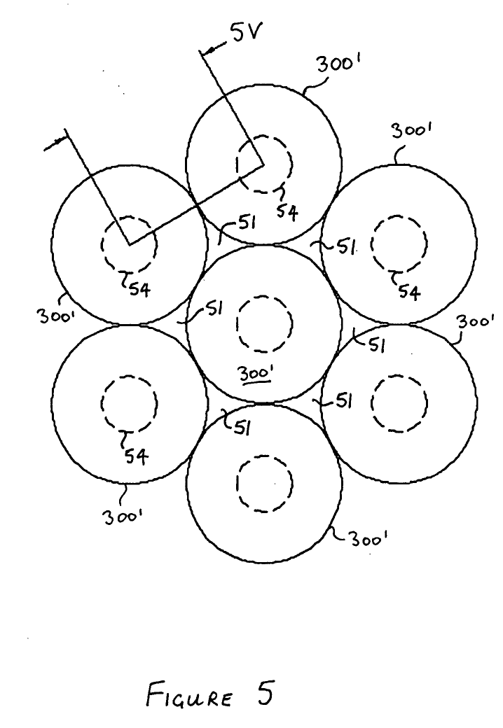

FIG. 6 is a graph showing the test results for cable according to the present invention. The graph plots “Power Sum Alien Near End Cross Talk” labelled as PSANEXT against the test signal frequency measured in Frequency MHz. The line drawn as line 6S is the recommended maximum acceptable level of cross-talk. The line 6M shows the measured test results for the cable of the present invention. It can be seen that the cable of the present invention performs significantly better than required by the standard.

The cable final form is based on the Reuleaux Triangle, in mathematical circles this geometry is well known as the ‘smallest area for a given width of any curve of constant width’.

In cable ‘alien cross-talk’ terms, this means that finishing the cable as a reuleaux triangle enables a maximum separation between cables to be achieved, and therefore cable pairs, with a smallest possible finished cable product dimension.

This provides a solution to the ‘Alien Cross-talk’ issue and the advantages of weight and flexibility compared to equivalent dimension round, or other any other form, cables.

This embodiment of the invention relates to the performance of balanced twisted pair communications cables up to and beyond 500 MHz and in particular to the improvement of the rejection of coupled noise from other cables (known in the industry as ‘Alien Cross-talk’ or otherwise as ‘Cable to Cable’ cross-talk).

The use of the high frequency cable for the MHz range having at least one twisted pair of conductors forming at least a part of a core, the core being covered by sheathing, the sheathing having a cross sectional external shape in the form of a reuleaux polygon described herein solves a problem which cannot be resolved effectively with conventionally designed UTP cables. The particular shape and construction of this high frequency cable also allows the cables made using this technology to be terminated in the same manner as known UTP cables. Known termination tools, such as cutting tools, and plugs intended to accept known UTP cable will accept the cable according to this invention.

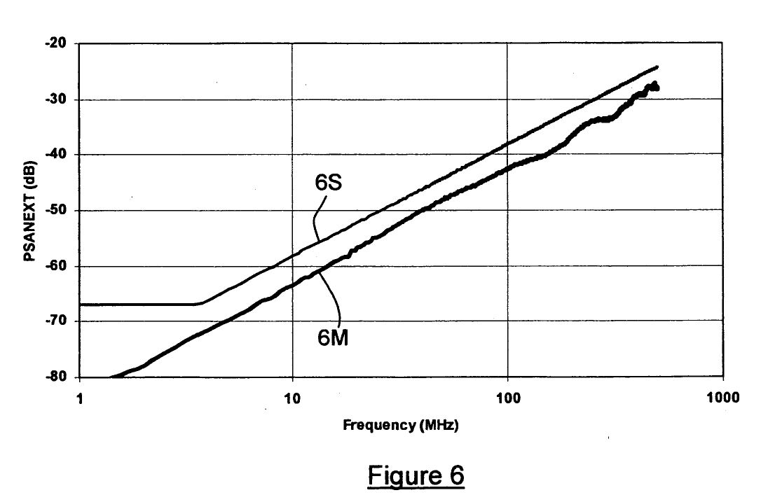

From FIG. 7, a perspective view of a second embodiment of an electrical cable 71 according to the invention is shown. The electrical cable 71 has an extruded sheathing 79 covering a core as in the first embodiment. An external shape of surface 73 of the sheathing 79 is substantially in the form of a reuleaux polygon 75, and in this embodiment is in the form of a three sided polygon having curved sides. Each of the apices 70, 72 and 74 of the reuleaux polygon 75 are provided with an external protrusions 76, 77 and 78. Fillet radii are provided to blend into the adjacent curved sides so that an external surface of the cable is smoothly curved around its periphery.

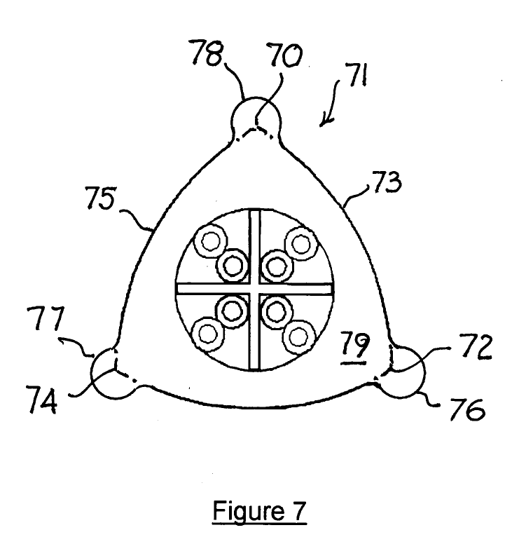

From FIG. 8, a perspective view of a third embodiment of an electrical cable 81 according to the invention is shown. The electrical cable 81 has an extruded sheathing 89 covering a core as in the first embodiment. An external shape of surface 83 of the sheathing 89 follows a linear path within the form 85 of a three sided reuleaux polygon, such that the linear sides each terminate on the form 85. The reuleaux polygon has apices 80, 82 and 84.

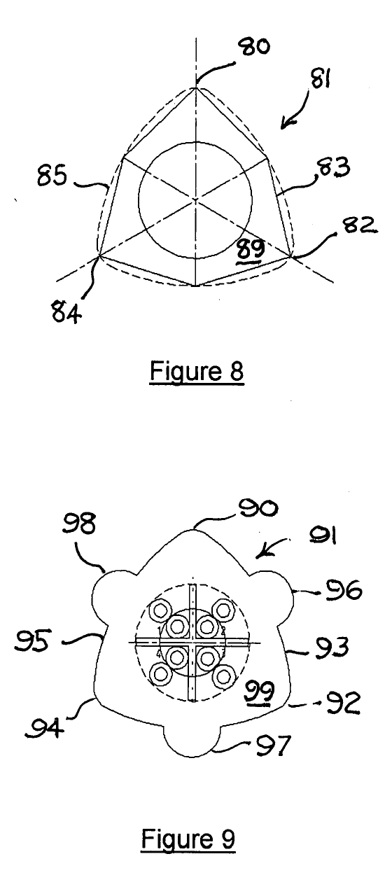

From FIG. 9, a perspective view of a fourth embodiment of an electrical cable 91 according to the invention is shown. The electrical cable 91 is similar to the first embodiment except that protrusions 96, 97 and 98 extend from external surface 93 of the external shape between apices 90, 92 and 94. The form of the reuleaux polygon is shown at 95.

The above description of preferred embodiments of the invention is given for the purposes of presenting an enabling description of the best mode of carrying out the invention and is not be construed as limiting the invention to the precise construction set forth herein. It will be appreciated that various modifications may be made to the invention described herein without departing from the spirit of the invention. The scope of the invention is to be limited only by the equivalents of the various elements set forth in the appended claims.

1. A high frequency cable for the MHz range, comprising: at least one twisted pair of conductors forming at least a part of a core, the core being covered by sheathing, the sheathing having a cross sectional external shape in the form of a reuleaux polygon.

2. A high frequency cable as claimed in claim 1, wherein the reuleaux polygon is a substantially triangular form.

3. A high frequency cable as claimed in claim 1 wherein the reuleaux polygon is six sided based on a triangular form.

4. A high frequency cable as claimed in claim 1 wherein the reuleaux polygon has a smoothly curved surface with a minimum radius at the corners being at least 10% of a width measured across the reuleaux polygon.

5. A high frequency cable as claimed in claim 2 wherein the reuleaux polygon has a smoothly curved surface with a minimum radius at the corners being at least 10% of a width measured across the reuleaux polygon.

6. A high frequency cable as claimed in claim 2 wherein the triangular form has outward extensions on the apices.

7. A high frequency cable as claimed in claim 1 wherein the cable is an unshielded twisted pair cable.

8. A high frequency cable as claimed in claim 1 wherein the cable is structured together with the sheathing extruded over the conductors such that the sheathing does not adhere to the conductors.

9. A high frequency cable as claimed in claim 1 wherein the cable sheathing includes ethylene vinyl acetate or poly-vinyl chloride.
